(19) United States
(12) Patent Application Publication
(10) Pub. No.: US 2016/0187279 A1
(43) Pub. Date: Jun. 30, 2016

(54) METAL OXIDE GAS SENSOR ARRAY DEVICES, SYSTEMS, AND ASSOCIATED METHODS

(71) Applicant: Intel Corporation, Santa Clara, CA (US)

(72) Inventors: Noureddine Tayebi, Menlo Park, CA (US); Pradyumna Singh, San Jose, CA (US)

(21) Appl. No.: 14/582,922

(22) Filed: Dec. 24, 2014

(51) Int. Cl. G01N 27/12

(52) U.S. Cl. CPC G01N 27/123; G01N 27/125

(57) ABSTRACT

Sensor devices and systems for detecting an analyte are disclosed and described. In one embodiment, a transducer array operable to detect a plurality of analytes is provided. Such an array may include a support substrate and a plurality of Metal Oxide Semiconductor (MOS) sensors coupled to the substrate. Each MOS sensor can further include a MOS active material, a plurality of heating elements thermally coupled to the MOS active materials in a position and orientation that facilitates heating of the MOS active materials, and an electrode functionally coupled to the MOS active material and operable to detect a response signal generated by the MOS active material.

### BACKGROUND

The testing of gases, volatile organic compounds (VOCs), and other airborne substances can be performed for a variety of reasons. One example is personalized health monitoring through breath analysis. Another example is pollution screening and/or monitoring. Yet other examples include environmental screening and/or monitoring, industrial process monitoring, and the like. A variety of sensors can be used to perform such testing to various degrees. Such sensors may vary in size, design, materials, and operation. For example, one design can employ Metal Oxide Semiconductor (MOS) technology in which a chemical reaction between gases or VOCs and an active layer in a MOS sensor generates a signal indicating a positive detection.

### BRIEF DESCRIPTION OF THE DRAWINGS

FIG. 1 is a schematic view of a MOS sensor in accordance with an invention embodiment;

FIG. 2 is a schematic view of a MOS sensor in accordance with an invention embodiment;

FIG. 3 is a schematic view of a MOS sensor array in accordance with an invention embodiment;

FIG. 4 is a schematic view of an analyte detection system in accordance with an invention embodiment; and

FIG. 5 is a depiction of a method for determining a composition of analytes in a gas environment in accordance with an invention embodiment.

### DESCRIPTION OF EMBODIMENTS

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a sensor” includes a plurality of such sensors.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term, like “comprising” or “including,” it is understood that direct support should also be afforded to “consisting essentially of” language as well as “consisting of” language as if stated explicitly and vice versa.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects or structures described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “analyte” refers to any molecule, compound, substance, agent, material, etc., for which detection is sought. In one aspect, an “analyte” may be capable of detection by a MOS sensor. In another aspect, an “analyte” can be capable of reacting with, and thus creating a detectable change in, a MOS active material. In some circumstances an “analyte” can be present in a gas environment. Non-limiting examples can include gases, airborne inorganic molecules, airborne organic molecules, volatile organic compounds, airborne particulate matter, and the like, including combinations thereof.

As used herein, “enhanced,” “improved,” “performance-enhanced,” “upgraded,” and the like, when used in connection with the description of a device or process, refers to a characteristic of the device or process that provides measurably better form or function as compared to previously known devices or processes. This applies both to the form and function of individual components in a device or process, as well as to such devices or processes as a whole.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### EXAMPLE EMBODIMENTS

An initial overview of technology embodiments is provided below and specific technology embodiments are then described in further detail. This initial summary is intended to aid readers in understanding the technology more quickly but is not intended to identify key or essential technological features, nor is it intended to limit the scope of the claimed subject matter.

Miniaturized standalone MOS-based gas sensors currently have several problems that limit the use of these devices. As one example, MOS sensors are generally simultaneously sensitive to multiple gases and/or VOCs. Not only does such cross-sensitivity preclude analyte-specific detection, but quantitative analysis of an analyte (e.g., measuring concentration) is generally not possible. While various modifications to MOS sensor designs, such as doping for example, can reduce the problem, analyte cross-sensitivity and consequent lack of selectivity still remains. As another example, the temperature at which a MOS sensor operates is generally kept constant, and does not allow for heating which may enhance selectivity to a given analyte. Additionally, the sensitivity of most MOS materials used in such sensors is affected by various environmental conditions, which can lead to erroneous readings due to the lack of proper calibration. One non-limiting example of such an environmental condition is humidity.

Invention embodiments relate to devices and systems having a low power, high sensitivity array of MOS sensors that can simultaneously and selectively detect chemical reactions involving one or more analytes and a reactant, such as adsorbed oxygen molecules, at the MOS active materials of the sensors. Such reactions cause changes in the electrical resistance of the MOS active material, thereby providing accurate concentrations of the analyte or analytes. In some cases, MOS sensor array devices can be used to monitor air quality in an immediate microenvironment. In the case of health monitoring, for example, such a device can provide a user with health implications associated with that direct environment, and can thus assist the user to avoid potentially detrimental effects of that environment (e.g., respiratory conditions such as Asthma or Chronic obstructive pulmonary disease (COPD) attacks).

More specifically, in one aspect an array of MOS-based sensors is presented that can provide single or multiple analyte selectivity including, in some aspects, concentration measurements for single and/or multiple analytes. While the design elements of a given MOS sensor can vary, each sensor in an array can be “tuned” to various analytes or groups of analytes. As one example, MOS sensors in an array can be individually heated to “tune” the MOS sensors to be selective, or at least more selective, to specific analytes or groups of analytes. Moreover, different MOS active materials can be sensitive to different analytes, and can thus be utilized to generate specific analyte selectivities. As such, by utilizing individual MOS sensor heating, different MOS active materials, and/or other techniques for tuning individual MOS sensors, arrays having highly selective analyte selectivities can be designed and implemented.

Various MOS sensor designs are contemplated that can be utilized in the implementation of various invention embodiments, and such sensor designs can vary depending on a variety of factors, including the preferences of the designer or user of a given sensing device. The scope of the present disclosure is not limited, therefore, to any specific MOS sensor design.

In one aspect, MOS analyte sensor functionality can be based on a change in electrical resistance of a MOS active material (i.e., the sensing layer) as a result of an interaction with an analyte. Once in contact with the analyte, the change in resistance of the MOS film can be detected. In some aspects it can be helpful to heat the MOS active material to facilitate the interaction and/or change in the resistance of the material. Additionally, the temperature to which the MOS active material is heated can affect the sensitivity of the active material to an analyte or analytes, and can thus be utilized to increase or decrease a MOS sensors selectivity to a given analyte or analytes.

Generally, a MOS sensor can include a MOS active or sensing material and a heating element to heat the MOS active material to a temperature at which analyte detection is performed. Various additional components can also be included in a MOS sensor, such as temperature sensors, environmental sensors, electrodes, readout circuitry, and the like. A given sensor array can have all MOS sensors of the same design and having the same sensor components, or the sensor array can have different MOS sensor designs and/or components across the array.

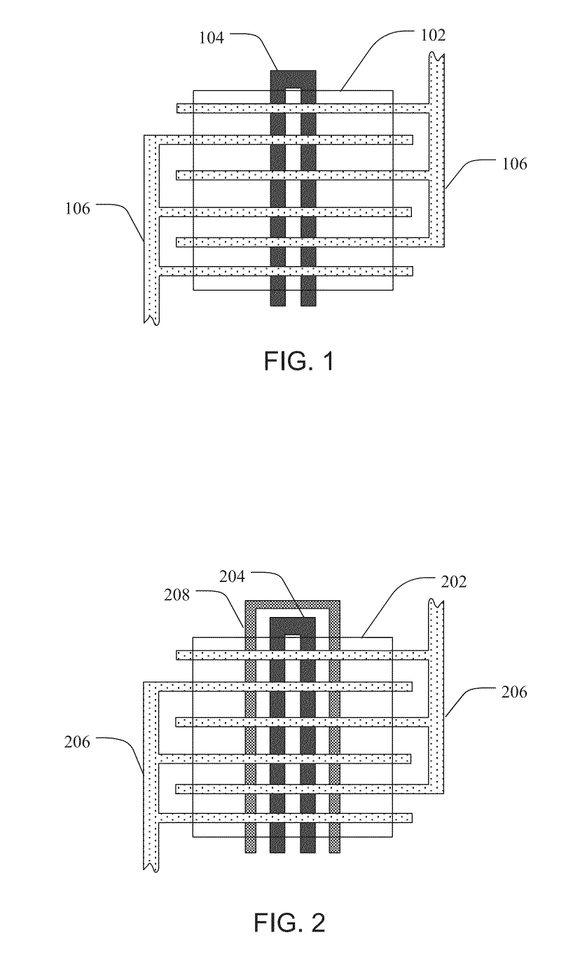

One non-limiting example of a MOS sensor is shown in FIG. 1. The sensor can include a MOS active material 102 positioned to be exposed to a sample to be tested. Note that the MOS active material 102 is shown as a transparent layer in FIGS. 1 and 2 to allow the underlying structures to be more clearly shown. A heating element 104 is thermally coupled to the MOS active material 102, and is positioned to facilitate heating of the MOS active material. In some embodiments, heating element geometry may be specifically configured in order to lower or minimize power consumption, lower or minimize heat dissipation, or provide uniform heating. In some embodiments, more than one such advantage can be obtained with a single heating element geometry or configuration. The device can further include one or more electrodes 106 to provide further functionality. For example, in one aspect the electrode 106 can receive and transmit signals generated in the MOS active material. In some cases a reaction between the MOS active material and an analyte results in a resistance change that can be detected by the electrode. In addition to analyte-related signals (including signals indicating the absence of an analyte), the electrode can receive and transmit signals relating to analyte concentration, the temporal fluctuations in analyte level, as well as signals from other components or modules of the device. Advantageously, in some embodiments, the geometry or configuration of the electrode can be specifically selected to increase or otherwise maximize sensitivity to resistance change in the MOS, and/or to fit a resistance range that is compatible with a readout circuit.

FIG. 2 shows another non-limiting example of a MOS sensor including a MOS active material 202 positioned to be exposed to a sample to be tested and a heating element 204 thermally coupled to the MOS active material 202 and positioned to facilitate heating of the MOS active material. The device includes one or more electrodes 206, and a temperature sensor 208 thermally coupled to the MOS active material 202. The temperature sensor can thus detect and/or monitor the temperature of the MOS active material. In some cases, the temperature sensor can detect and report heating conditions generated by the heating element so that the heating of the MOS can be controlled, tuned, or otherwise optimized for a given application. Because the local temperature has a tendency to drift due to thermal fatigue or non-homogeneous dissipation mechanisms (presence of convection and/or radiation), for example, the uniform heating of the MOS active material can be affected, thus disrupting precise and reproducible temperatures. By reading the temperature at the MOS active material and being able to control it precisely, the detection sensitivity of the sensor can be more accurately ascertained, particularly for sensors having a temperature-dependent selectivity to a particular analyte or group of analytes. The temperature sensor can transmit signal to and from the sensor via one or more dedicated electrical channels, or via a shared electrical channel such as the electrode or other electrically useful connection.

In another aspect, a plurality of MOS sensors is included in an array to provide selectivity to one or more analytes or groups of analytes. Additionally, such an array can provide effective identification and quantification of complex samples of related or unrelated analyte mixtures. For arrays having a size of three or more, MOS sensor arrangements can be in a linear or in a two-dimensional array pattern. A given array can include at least two MOS sensors, where each MOS sensor has the same, similar, or different analyte selectivity as compared to other MOS sensors in the array. In one aspect, a MOS sensor array can selectively detect at least two analytes. In some cases, each of the MOS sensors in an array can be selective to a different analyte. In other cases, one or more MOS sensors in an array can be selective to a given analyte. As one example, half of the MOS sensors in an array can be selective to one analyte, while the other half of the MOS sensors can be selective to another analyte. In another example, multiple groups of MOS sensors can be included in an array, where each group is selective to a different analyte or group of analytes.

Furthermore, in some cases the individual MOS sensors of an array may not be selective to a specific analyte or analytes, and analyte selectivity of the array is a result of the pattern of partial or cumulative response generated by the array as a whole. In other words, a plurality of MOS sensors can be used as a collective to generate such selectivity. In some embodiments, the individual MOS sensors in the array are not sufficiently selective to distinguish between multiple analytes by themselves. In additional embodiments, the MOS sensors may have differing response characteristics to an analyte in a sample. The differing responses across the MOS sensors in the array can be used as a type of “fingerprint” or pattern to selectively distinguish between analytes that are indistinguishable or difficult to distinguish by the response characteristics of single MOS sensors alone. Once a pattern for an analyte or a mixture of analytes is established, the response of the array to a sample can be compared to that pattern to determine if the analyte or mixture of analytes is present. This pattern recognition process can be used to selectively distinguish a single analyte, a few analytes, as well as complex mixtures of analytes in a sample. While the detection of an analyte or analytes can be dependent on matching a known response pattern to the response of the array, in some cases statistical or other pattern recognition techniques can be employed to selectively detect one or more analytes to which a response pattern is not known. For example, the identity of a mixture of analytes in a sample can be extrapolated from known response patterns of the array to other analytes or mixtures of analytes.

Furthermore, pattern recognition processes can be utilized in an array having analyte-selective MOS sensors. In some cases, for example, a portion of an array can include analyte-selective MOS sensors, and another portion can include analyte-nonselective MOS sensors that utilize pattern recognition for analyte detection. Additionally, in some cases a pattern recognition process can be applied to the response patterns of analyte-selective MOS sensors to detect unknown analytes, analyte mixtures, or analyte mixture concentrations.

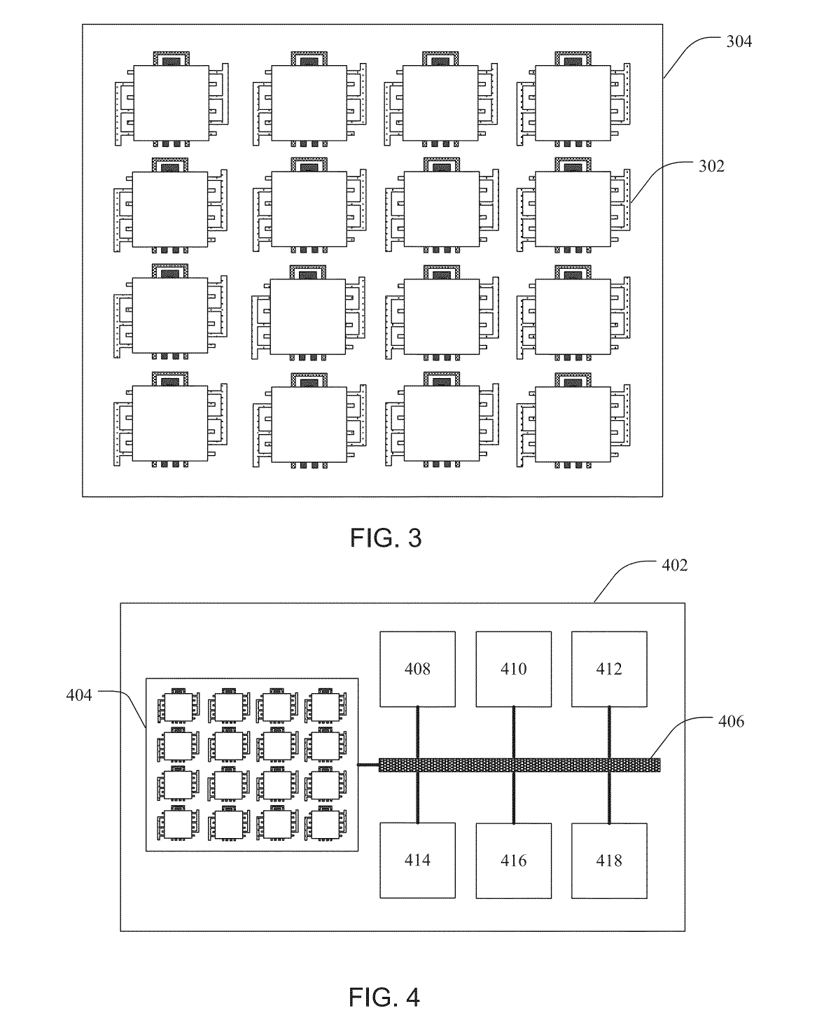

One non-limiting example of a MOS sensor array is shown in FIG. 3, where 16 MOS sensors 302 are arranged into a four-by-four grid on a support substrate 304. It is noted that connections to and from the MOS sensors are not shown. While there is no limit to the number of MOS sensors included in an array, in some aspects the array can include at least four MOS sensors. In other aspects, the array can include at least 16 MOS sensors. In yet other aspects, the array can include at least 24 MOS sensors. In further aspects, the array can include at least 64 MOS sensors. In yet further aspects, the array can include at least 256 MOS sensors.

Each MOS sensor in an array can include a MOS active material and a heating element thermally coupled to the MOS active material in a position and orientation to facilitate heating of the MOS active material. One or more temperature sensors can additionally be included in the array. A temperature sensor can be integrated into each MOS sensor as described above, or a temperature sensor can be incorporated at the array level to sense and monitor temperature across a region of multiple MOS sensors.

As has been described, an array can include analyte-selective MOS sensors, analyte-nonspecific MOS sensors, or a combination thereof, including combinations of specific analyte-selective MOS sensors that are selective for the same or different analytes. In the case of analyte-selective MOS sensors, various potential mechanisms can be utilized to generate such selectivity in a sensor. It is noted that any mechanism, characteristic, or property that is capable of tuning a MOS sensor to increase the response selectivity to a given analyte or analytes is considered to be within the present scope. It is additionally noted that the selectivity of a single MOS sensor can include an unambiguous determination of the presence of an analyte, as well as a statistically significant determination. Furthermore, selectivity can additionally be defined based on the intended use of the device. For example, a MOS sensor can be categorized as selectively tuned to an analyte even though there may be cross-selectivity to another analyte that is unlikely to be present in the sample, or that is already known to be present in the sample. For example, a MOS sensor that has cross selectivity for an analyte of interest and nitrogen can be categorized as selective for that analyte when testing an air sample, provided the response to the analyte is detectable above the response to nitrogen.

Analyte selectivity can be achieved through a variety of mechanisms. While analyte selectivity can be a result of non-intentional or random manufacturing conditions, in some cases a MOS sensor can be purposefully tuned to achieve selectivity to a particular analyte. Such tuning can include alterations to sensor materials or to structural arrangements of sensor materials that increase selectivity to an analyte or analytes. For example, tuning can be achieved at the MOS active material by altering the constituents, thickness, porosity, and/or reactivity of the material. In addition to doping, different MOS active materials and/or material compositions can be utilized to increase selectivity to a given analyte. Furthermore, a coating applied to the MOS active material can act as a filter to alter the selectivity of the sensor, such as, for example, a porous polymer coating. Furthermore, in some embodiments, the filter need not be a coating on the MOS active material, but can merely be coupled to or otherwise associated with the MOS active material in a fashion that allows the filter to perform its desired function and have a desired effect, such as for example, by altering the timing at which different analytes reach the MOS active material. Examples, porous polymers can include without limitation, porous polymer networks with Tetrahedral monomers such as TEPM, TEPA and TBPA. Polytetrafluroethylene (PTFE) can also be used in some embodiments. Additional examples include nanofiber based filtering media, such as a collection of fibers having diameters about 10 nm to about 1000 nm. Nearly any other membrane or filter structure or material can be used as long as it does not impede the intended function of the sensor device. In a further embodiment, one or more catalysts associated with or within the MOS active material can be used to alter analyte selectivity.

In addition to changes to the active material itself, MOS sensors can also be tuned to be selective to an analyte by adjusting the degree of heating applied to the active material. This differential heating (i.e. multiplexed heating) can be a characteristic designed into each MOS sensor, or it can be a temperature regulation mechanism at the array level. A MOS sensor tuned to heat the active material to an analyte-specific range can include any design element capable of achieving such tuning. Non-limiting examples can include alterations to the heating element material, limiting current to the heating element, alteration of the thickness of material layers between the heating element and the MOS active material, additional materials positioned between the heating element and the MOS active material, and the like, including combinations thereof.

Accordingly, an array of MOS sensors can achieve selectivity to an analyte or analytes through a variety of mechanisms, whether at the sensor level or the array level. Some arrays can include MOS sensors that are all different from one another, where each sensor has a different analyte selectivity. Other arrays can include MOS sensor that are all the same or substantially the same, and the analyte selectivity is generated at the array level through a mechanism such as differential heating and/or through pattern recognition. Yet other arrays can include a combination of MOS sensors that each have a different analyte selectivity and MOS sensors that have the same or substantially the same analyte selectivity.

MOS active materials in general can include any metal oxide material that is capable of being used in a sensor to detect an analyte. Non-limiting examples of such materials can include SnO₂, V₂O₅, WO₃, Cr₂₋ₓTiₓO_{3+z}, ZnO, TeO₂, TiO₂, CuO, CeO₂, Al₂O₃, ZTO₂, V₂O₃, Fe₂O₃, MO₂O₃, Nd₂O₃, La₂O₃, Nb₂O₅, Ta₂O₅, In₂O₃, GeO₂, ITO, and the like, including combinations thereof and various stoichiometric ratios thereof. Thickness of the MOS active material can vary depending on the MOS sensor design and according to the tuning of the sensor, as has been described. Generally, the thickness of the MOS active material should be within the depth of change of the MOS work function but could also be thicker.

Additionally, the MOS active material can be doped, either to affect analyte selectivity or for other functionality of the sensor. Any dopant that is useful in the construction or use of the MOS sensor can be used to dope the active material. Non-limiting examples can include Pt, Pd, W, Au, In, Ru, BIn₂O₃ and the like, including combinations thereof. In some cases, a dopant can include any useful catalyst. In other cases, a dopant can include a noble metal. It is noted that, in addition to increasing selectivity, the MOS active material can be doped to decrease selectivity towards an analyte or analytes.

The heating element of a MOS sensor can include any type of heat-generating component or structure capable of selectively providing heat to the MOS active material. In one aspect the heating element can be a resistive heating element that includes any type of conductive wire or other structure that can be locally heated by applying a voltage. The heating element can thereby heat the MOS active material to a desired temperature at which analyte detection is performed. Depending on the MOS material used and the analytes being detected, a non-limiting operating temperature range can typically be from about 20° C. to about 500° C. The thickness, material, and/or structural configuration of the heating element can vary, depending on the design of the sensor and the desired analyte selectivity to be achieved. In some aspects the heat element material can include a dopant to affect the heating properties of the material.

The temperature sensor can include any material or structural configuration that allows sensing and/or monitoring of temperature. In one specific aspect, for example, the temperature sensor can be a conductive wire that changes in resistance with a change in temperature, to thereby allow for accurate temperature monitoring. In some aspects the heating element and the temperature sensor can be isolated from the MOS active area by an insulating layer. The thickness of the insulating layer can be varied to further affect the heating of the MOS active material.

Additionally, in some cases a feedback element can be coupled to the heating element and the temperature sensor to regulate heating by the heating element. The feedback element can be an electronic component or circuit that can regulate the temperature of the heating element to a set point or range of set points.

The electrode materials can include any material capable of detecting a resistance change or other reaction at the MOS active material, and transmitting a signal indicating that resistance change from the MOS sensor. The electrode can be directly or indirectly connected to the MOS active material, and can include the same or different materials for the detecting and transmitting of the signal. In one non-limiting example, the electrode can be in an interdigitated arrangement, the same or similar to that shown in FIGS. 1 and 2.

The sensitivity of sensor arrays according to aspects of the present disclosure can be affected by a variety of factors. In addition to temperature sensors, MOS sensor arrays can include various sensors to monitor and/or account for such factors. Non-limiting examples of such factors can include sensor effects due to temperature, humidity, aging, non-specific adsorption, flow rate variation, thermo-mechanical degradation, poisoning, and the like, each of which can lead to erroneous detections of analytes. Sensors that monitor one or more of these factors can be used to provide calibration to the array, to indicate needed service of the device, to indicate an inappropriate environment for analyte testing, and the like. Such sensors can be integrated at the MOS sensor level or at the array level, depending on the design of the device. Furthermore, such sensors can be external components integrated at the level of a printed circuit board (PCB) or other system level.

Furthermore, one or more environmental sensors can be incorporated into the MOS sensor array or into the MOS sensor device interfaced with the array. An environmental sensor can detect thus at least one environmental condition. While any useful environmental condition is contemplated, in one aspect the environmental sensor can be a humidity sensor. Humidity can affect the sensor reading of the array, and as such, a humidity sensor can be utilized to calibrate the array to a given humidity level. As such, readings in an environment having a level of humidity that can affect the analyte detection and/or analyte concentration can be adjusted to compensate, thus providing much more accurate analyte analysis as compared to non-adjusted readings. Environmental sensors can be integrated at the MOS sensor level or at the array level, depending on the design of the device.

An analyte detection system operable to detect a plurality of analytes is shown in FIG. 4. Such a system can include an application specific integrated circuit (ASIC) 402, a transducer or MOS sensor array 404 functionally coupled to the ASIC 402, and an I/O module 406 functionally coupled to the ASIC and the transducer array, which can function to at least provide control and data communication there between. In one aspect, the ASIC and the MOS sensor array can be monolithically integrated. In another aspect, the ASIC and the MOS sensor array can be formed separately and coupled together. The I/O module can be any communication network, pathway, or connection including, without limitation, an I/O bus or other circuitry.

A given analyte detection system can additionally include a heating control module 408, that can be functionally coupled to the I/O module 406, and can operate to control heating of the plurality of heating elements in the MOS sensor array 404. Additionally, the heating control module can functionally couple with the temperature sensors, and can thus monitor and/or control the output of the heating elements based on the temperature sensor readings.

Additionally, various modules can be included to address and readout signal from the array. For example, a readout module 410 can be functionally coupled to the I/O module 406, and can operate to read out data from the plurality of MOS sensors in the MOS sensor array 404. An address module 412 can be functionally coupled to the I/O module 406, and can operate to address the MOS sensor array. The design of a given array, and thus the addressing and readout modules can vary in design and or functionality. For example, the ASIC 402 can be a CMOS ASIC, and therefore the addressing and readout modules can be based on CMOS processing. In other examples, readout can occur similar to a charged coupled device (CCD) readout, a PCB-level readout, or any number of other ASIC or non-ASIC readout and addressing schemes.

MOS sensor array systems can also include various data processing and memory modules. For example, a system can include one or more data or signal processing modules 414 functionally coupled to the I/O module 406. Such processing modules can operate to accomplish a variety of tasks, including, without limitation, pattern recognition, pattern extrapolation, concentration or other quantitative analysis, qualitative analysis such as, for example, analyte detection and/or analyte mixture detection, environmental analysis, system status analysis, and the like. It is noted that various functionality can be incorporated into a dedicated module, such as, for example, an environmental analysis module. A data processing module can additionally perform signal processing functions on data received from the readout module, such as, for example, signal amplification and/or filtering. A given processing module function can be accomplished using common or dedicated circuitry and/or processors. For example, pattern recognition can be accomplished using a common circuitry with concentration analysis, or the two processes can have distinct circuitries. One or more nonvolatile memory modules 416 can additionally be included to store a variety of data, including calibration information that can be used to compensate for environmental factors, material aging, etc., pattern recognition data, and the like. Various algorithms useful for system control, data manipulation, and/or data analysis can also be resident in a memory module. Non-limiting examples can include matrix transform, genetic algorithms, component correction and principal component analysis, orthogonal signal correction based methods, and the like.

The MOS sensor array system can also include one or more control modules 418 functionally coupled to the I/O module 406. Control modules can operate to control system-level processes such as the heating module, the readout module, etc. Control modules can also operate to control functionality at the array or at the MOS sensor level, such as, for example, monitoring the temperature sensors and controlling the heating elements. In this case, the heating control module is included in the functionality of the control module. Additionally, the control module 418 can accept input and/or programming, thus allowing a user to interact with the system.

Accordingly, in one example signals are detected by the array of MOS sensors and read out by the ASIC or other readout platform, the identities of the various analytes generating the signals are identified, and the concentration of each analyte is determined by the system with a high reliability during the life-time of the sensor array, irrespective of the environmental conditions and aging degradation. The present systems can further include a power supply (not shown).

The MOS devices and sensor arrays of the present disclosure can be fabricated according to any technique or method. For example, such arrays can be made using techniques such as micromachining, MEMS, and microelectronics techniques, printing technologies, chemical synthesis, and the like, including combinations of some or all of these techniques. Furthermore, in cases where an ASIC is used, the MOS sensor array can be integrated with the ASIC either monolithically by post-processing the array directly on the ASIC substrate or in hybrid fashion by fabricating the array separately and using wire-bonding or through-silicon vias (TSVs). In some cases, the ASIC can provide multiplex heating and sensing (MOS resistance change and local temperature), signal amplification, analog to digital conversion and digital output with address based data. It can also include programmable and memory blocks for signal processing, pattern recognition and calibration data for temperature and environmental effect compensations.

As to specific details, the microfabrication of MOS arrays can be performed according to any number of well-known fabrication techniques, and one of ordinary skill in the art would readily be able to fabricate such an array once in possession of the present disclosure.

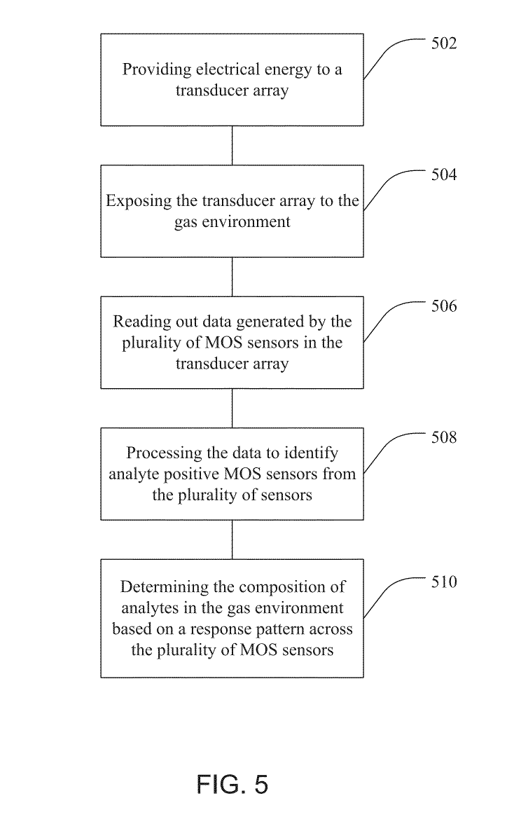

As is shown in FIG. 5, the present disclosure additionally provides exemplary methods for determining a composition in a gas environment. Such a method can include 502 providing electrical energy to a transducer array of the present disclosure, 504 exposing the transducer array to the gas environment, 506 reading out data generated by the plurality of MOS sensors in the transducer array, 508 processing the data to identify analyte positive MOS sensors from the plurality of sensors, and 510 determining the composition of analytes in the gas environment based on a response pattern across the plurality of MOS sensors.

In some aspects, the method can further include quantifying each analyte in the composition of analytes from the response of each of the MOS sensors. Quantifying can include any analysis of quantitative data such as, for example, analyte concentration. In another aspect, quantifying each analyte further includes comparing the response from the analyte positive MOS sensors against a previously generated analyte pattern.

### EXAMPLES

The following examples pertain to further embodiments.

In one example, there is provided a transducer array operable to detect a plurality of analytes comprising:

a support substrate;

a plurality of Metal Oxide Semiconductor (MOS) sensors coupled to the substrate, where each MOS sensor further comprises a MOS active material;

a plurality of heating elements thermally coupled to the MOS active materials of the plurality of MOS sensors in a position and orientation that facilitates heating of the MOS active materials; and

an electrode functionally coupled to the MOS active material and operable to detect a response signal from the MOS active material.

In one example, the array can further comprise at least one temperature sensor thermally coupled to at least one of the plurality of MOS sensors.

In one example, the array can further comprise a plurality of temperature sensors thermally coupled to the MOS active materials of the plurality of MOS sensors.

In one example, the array can further comprise feedback elements coupled to the heating elements and the temperature sensors, the feedback elements operable to regulate heating by the heating element.

In one example, at least a portion of the plurality of MOS sensors are each tuned to detect a specific analyte.

In one example, the plurality of MOS sensors are each tuned to detect a specific analyte.

In one example, at least a portion of the plurality of heating elements include different designs in order to heat the associated MOS active materials to different temperatures for the same energy input.

In one example, the specific analyte includes an analyte selected from the group consisting of gases, airborne inorganic molecules, airborne organic molecules, volatile organic compounds, airborne particulate matter, and combinations thereof.

In one example, the different designs include heating elements having different materials.

In one example, different materials include materials having a different doping profile.

In one example, the different designs include heating elements having different positioning relative to the MOS active material.

In one example, the different designs include heating elements having different structural elements.

In one example, the MOS active materials for at least a portion of the plurality of MOS sensors are each tuned to detect a specific analyte.

In one example, the MOS active materials for the plurality of MOS sensors are each tuned to detect a specific analyte.

In one example, the tuning to detect a specific analyte is due to different MOS active materials.

In one example, the tuning to detect a specific analyte is due to a filter coating functionally associated with the MOS active materials.

In one example, the tuning to detect a specific analyte is due to the thickness of the MOS active materials.

In one example, the tuning to detect a specific analyte is due to a catalyst functionally associated with the MOS active materials.

In one example, the tuning to detect a specific analyte is due to different doping profiles of the MOS active materials.

In one example, the MOS active materials are doped with a dopant selected from the group consisting of Pt, Pd, W, Au, In, Ru, BIn₂O₃, or combinations thereof.

In one example, the MOS active materials include materials selected from the group consisting of SnO₂, V₂O₅, WO₃, Cr₂₋ₓTiₓO_{3+z}, ZnO, TeO₂, TiO₂, CuO, CeO₂, Al₂O₃, ZTO₂, V₂O₃, Fe₂O₃, MO₂O₃, Nd₂O₃, La₂O₃, Nb₂O₅, Ta₂O₅, In₂O₃, GeO₂, ITO, or combinations thereof.

In one example, the plurality of MOS sensors includes at least four MOS sensors.

In one example, the plurality of MOS sensors includes at least 24 MOS sensors.

In one example, the plurality of MOS sensors includes at least 64 MOS sensors.

In one example, the plurality of MOS sensors includes at least 256 MOS sensors.

In one example, the plurality of MOS sensors are arranged in a two-dimensional array configuration.

In one example, is provided an analyte detection system operable to detect a plurality of analytes comprising:

an application specific integrated circuit (ASIC);

a transducer array of claim 1 functionally coupled to the ASIC;

an I/O module functionally coupled to the ASIC and to the transducer array and operable to provide control and data communication therebetween;

a heating control module functionally coupled to the I/O module and operable to control heating of the plurality of heating elements;

a readout module functionally coupled to the I/O module and operable to read out data from the plurality of MOS sensors; and

an address module functionally coupled to the I/O module and operable to address the transducer array.

In one example, the system can further comprise a data processing module functionally coupled to the I/O module and operable to perform signal data processing operations.

In one example, the system can further comprise a plurality of temperature sensors thermally coupled to the MOS active materials of the plurality of MOS sensors.

In one example, the heating control module is further operable to monitor temperature at the plurality of temperature sensors.

In one example, the system can further comprise a signal processing module functionally coupled to the I/O module and operable to perform signal processing operations on sensor data received from the readout module.

In one example, the system can further comprise a memory module functionally coupled to the I/O module.

In one example, the nonvolatile memory module includes calibration data resident therein.

In one example, the system can further comprise a pattern recognition module functionally coupled to the I/O module containing pattern recognition data, wherein the pattern recognition module operable to identify at least one analyte from sensor data from the plurality of MOS sensors.

In one example, the pattern recognition module is operable to identify a plurality of analytes from sensor data from the plurality of MOS sensors generated in a complex analyte environment.

In one example, the pattern recognition module is operable to provide quantitative data regarding the plurality of analytes in the complex analyte environment.

In one example, the quantitative data includes analyte concentration data.

In one example, the system can further comprise at least one environmental sensor functionally coupled to the I/O module and operable to detect at least one environmental condition.

In one example, the environmental condition is humidity.

In one example, the system can further comprise an environmental module functionally coupled to the I/O module and operable to receive environmental data from the at least one environmental sensor.

In one example, the environmental module is operable to provide calibration control to the heating module based on the environmental data.

In one example, the ASIC is a CMOS ASIC.

In one example, the transducer array and the ASIC are monolithically integrated.

In one example, the transducer array is made separately from and physically coupled to the ASIC.

In one example, the transducer is electrically coupled to the ASIC by vias.

In one example, there is provided a method for determining a composition of analytes in a gas environment comprising:

providing electrical energy to a transducer array as exemplified;

exposing the transducer array to the gas environment;

reading out data generated by the plurality of MOS sensors in the transducer array;

processing the data to identify analyte positive MOS sensors from the plurality of sensors; and

determining the composition of analytes in the gas environment based on a response pattern across the plurality of MOS sensors.

In one example, the method can further comprise quantifying each analyte in the composition of analytes from the response of each of the analyte positive MOS sensors.

In one example, quantifying each analyte further includes comparing the response from the analyte positive MOS sensors against a previously generated analyte pattern.

In one example, the method can further comprise determining an environmental condition and calibrating the transducer array to account for the environmental condition.

In one example, the method can further comprise determining an environmental condition and transforming the data generated by the plurality of MOS sensors to account for the environmental condition.

In one example, the environmental condition is humidity.

While the forgoing examples are illustrative of the specific embodiments in one or more particular applications, it will be apparent to those of ordinary skill in the art that numerous modifications in form, usage and details of implementation can be made without departing from the principles and concepts articulated herein. Accordingly, no limitation is intended except as by the claims set forth below.

What is claimed is:

1. A transducer array operable to detect a plurality of analytes, comprising:
a support substrate;
a plurality of Metal Oxide Semiconductor (MOS) sensors coupled to the substrate, each MOS sensor further comprising a MOS active material;
a plurality of heating elements thermally coupled to the MOS active materials of the plurality of MOS sensors in a position and orientation that facilitates heating of the MOS active materials; and
an electrode functionally coupled to the MOS active material and operable to detect a response signal from the MOS active material.

2. The array of claim 1, further comprising at least one temperature sensor thermally coupled to at least one of the plurality of MOS sensors.

3. The array of claim 2, further comprising feedback elements coupled to the heating elements and the temperature sensors, the feedback elements operable to regulate heating by the heating element.

4. The array of claim 1, wherein the MOS active materials for at least a portion of the plurality of MOS sensors are each tuned to detect a specific analyte.

5. The array of claim 4, wherein the MOS active materials for the plurality of MOS sensors are each tuned to detect a specific analyte.

6. The array of claim 4, wherein the tuning to detect a specific analyte is due to different MOS active materials.

7. The array of claim 1, wherein the MOS active materials include one or more materials selected from the group consisting of SnO2, V2O5, WO3, Cr2−xTixO3+z, ZnO, TeO2, TiO2, CuO, CeO2, Al2O3, ZrO2, V2O3, Fe2O3, Mo2O3, Nd2O3, La2O3, Nb2O5, Ta2O5, In2O3, GeO2, ITO, or combinations thereof.

8. The array of claim 1, wherein the plurality of MOS sensors includes at least four MOS sensors.

9. The array of claim 1, wherein the plurality of MOS sensors are arranged in a two-dimensional array configuration.

10. An analyte detection system operable to detect a plurality of analytes, comprising:
an application specific integrated circuit (ASIC);
a transducer array of claim 1 functionally coupled to the ASIC;
an I/O module functionally coupled to the ASIC and to the transducer array and operable to provide control and data communication there between;
a heating control module functionally coupled to the I/O module and operable to control heating of the plurality of heating elements;
a readout module functionally coupled to the I/O module and operable to read out data from the plurality of MOS sensors; and
an address module functionally coupled to the I/O module and operable to address the transducer array.

11. The system of claim 10, further comprising a data processing module functionally coupled to the I/O module and operable to perform signal processing operations.

12. The system of claim 10, further comprising a plurality of temperature sensors thermally coupled to the MOS active materials of the plurality of MOS sensors.

13. The system of claim 12, wherein the heating control module is further operable to monitor temperature at the plurality of temperature sensors.

14. The system of claim 10, further comprising a signal processing module functionally coupled to the I/O module and operable to perform signal processing operations on sensor data received from the readout module.

15. The system of claim 10, further comprising a memory module functionally coupled to the I/O module.

16. The system of claim 15, wherein the memory module includes calibration data resident therein.

17. The system of claim 10, further comprising a pattern recognition module functionally coupled to the I/O module containing pattern recognition data, wherein the pattern recognition module is operable to identify at least one analyte from sensor data from the plurality of MOS sensors.

18. The system of claim 17, wherein the pattern recognition module is operable to identify a plurality of analytes from sensor data from the plurality of MOS sensors generated in a complex analyte environment.

19. The system of claim 10, wherein the ASIC is a CMOS ASIC.

20. A method for determining a composition of analytes in a gas environment, comprising:
providing electrical energy to the transducer array of claim 1;
exposing the transducer array to the gas environment;
reading out data generated by the plurality of MOS sensors in the transducer array;
processing the data to identify analyte positive MOS sensors from the plurality of sensors; and
determining the composition of analytes in the gas environment based on a response pattern across the plurality of MOS sensors.

21. The method of claim 20, further comprising quantifying each analyte in the composition of analytes from the response of each of the analyte positive MOS sensors.

22. The method of claim 21, wherein quantifying each analyte further includes comparing the response from the analyte positive MOS sensors against a previously generated analyte pattern.

23. The method of claim 20, further comprising determining an environmental condition and calibrating the transducer array to account for the environmental condition.

24. The method of claim 20, further comprising determining an environmental condition and transforming the data generated by the plurality of MOS sensors to account for the environmental condition.

25. The method of claim 24, wherein the environmental condition is humidity.
